(19) United States
(12) Patent Application Publication
(10) Pub. No.: US 2024/0328525 A1
(43) Pub. Date: Oct. 3, 2024

(54) Leaf Pot Pressure Relief Device

(71) Applicant: Charles W Wolford, Morris, AL (US)

(72) Inventor: Charles W Wolford, Morris, AL (US)

(21) Appl. No.: 18/128,102

(22) Filed: Mar. 29, 2023

(51) Int. Cl. F16K 24/04; B01D 35/147; E04H 4/12

(52) U.S. Cl. CPC F16K 24/04; B01D 35/1475; E04H 4/1218

(57) ABSTRACT

The invention disclosed provides for air pressure relief device for a leaf pot that is located in the top of a leaf pot lid that greatly increases the ability of a user to easily evacuate air that has entered the system by air inducing events that cause the pump to lose prime without having to remove the lid from the leaf pot.

### CROSS-REFERENCED TO RELATED APPLICATIONS

None

### FEDERALLY SPONSORED RESEARCH

None

### SEQUENCE LISTING

None

### FIELD OF THE INVENTION

The present invention relates to above ground swimming pool pre-filter leaf pots. More specifically, the present invention relates to a pressure release device and method of releasing pressure in a above ground swimming pool leaf pot pre-filter.

### BACKGROUND OF THE INVENTION

Above ground pools have filtration systems that often, if not always, contain a pre-filter or strainer commonly termed as a leaf pot or leaf basket. The leaf pot is a pre-filter for larger particles and items that collect in pools and are strained out of the water through a strainer basket that is located in the leaf pot. Leaf pots used in filtration systems almost always have a quarter turn locking screwable lid that a pool owner can remove to empty the contents that the strainer has collected. However, because of various different air introducing events that can occur during use of the pool, the leaf pot lid can accumulate air causing the pump to lose prim, therefore causing the circulation of water through the filtration system to stop. The leaf pot lid can be very difficult to remove and many individuals lack the strength to unscrew the lid. The introduction of air into the leaf pot creates a suction on the lid rendering it difficult to remove. Air introducing events include loss of water in a pool due to splashing activity in the pool, evaporation of water from the pool over time, and using a vacuum hose that attaches to the leaf pot whereby the vacuum hose is exposed to the atmosphere and sucks air into the system and leaf pot. What is needed in the art is a leaf pot lid that allows for easy evacuation of built-up air in the system or the influx of air into the leaf pot to alleviate a negative suction pressure.

### SUMMARY OF THE INVENTION

The present invention is a pressure relief valve that can be installed into an existing non-valve leaf pot cover. The present invention is also a leaf pot lid with a pre-existing valve manufactured into the leaf pot lid. The pressure relief valve has a circular base portion and a threaded post portion that is physical connection and located above the base portion. Located on top of the base portion is a rubber washer or grommet that is installed over the threaded post portion and is purposed to create a seal between the base portion of the pressure relief valve and the bottom surface of the leaf pot cover where an aperture is made in the leaf pot cover. The threaded portion of the pressure release valve is installed into the bottom side of the leaf pot cover in an aperture that is formed in a leaf pot cover. Once the threaded post is inserted through the aperture located on the leaf pot cover, a washer is installed onto the threaded portion of the pressure release valve located on the top of the leaf pot cover. Additionally, a paper or rubber washer can be installed on the threaded post portion. Also installed onto the threaded portion is a locking nut which is correspondingly threaded and allows the pressure relief valve to be locked into place by turning the nut and compressing the rubber washers or grommet. A sealant can be applied around the threaded post and washers to ensure that the threaded post connection with the leaf pot cover is sealed from allowing air to seep in or out of the leaf pot. A user can evacuate air via a valve core located inside of the threaded post portion to allow normalization of the water pressure inside the leaf pot which allows the pump to recover prime.

### BRIEF DESCRIPTION OF THE DRAWINGS

FIG. 1 is an exploded perspective view of the components of the pressure relief valve.

FIG. 2 is a perspective view of the pressure relief valve installed onto the leaf pot cover.

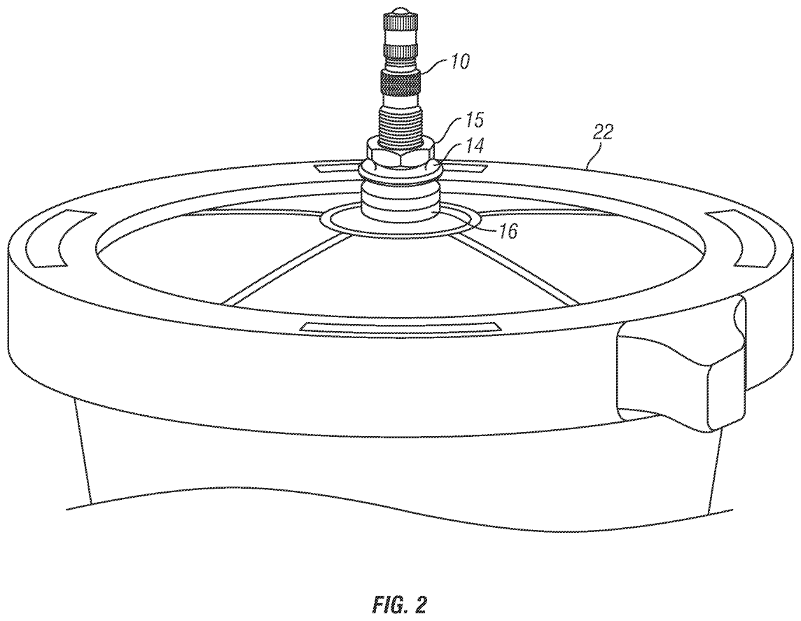

FIG. 3 is an exploded view of the pressure relief valve components and leaf pot cover.

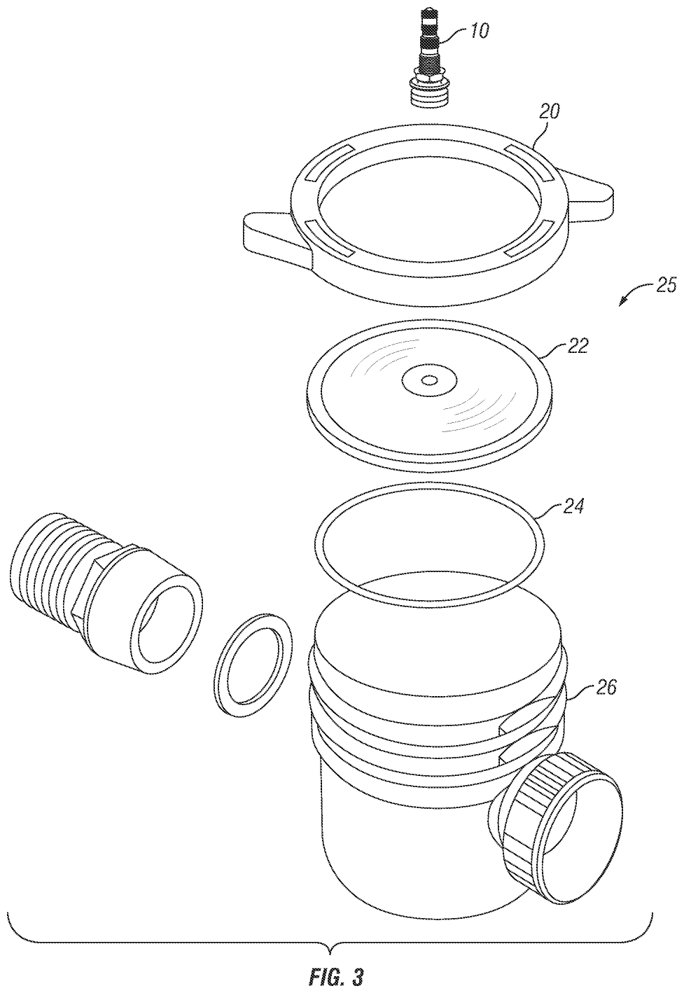

FIG. 4 is a bottom plan view of the of the leaf pot cover and the base portion of the valve.

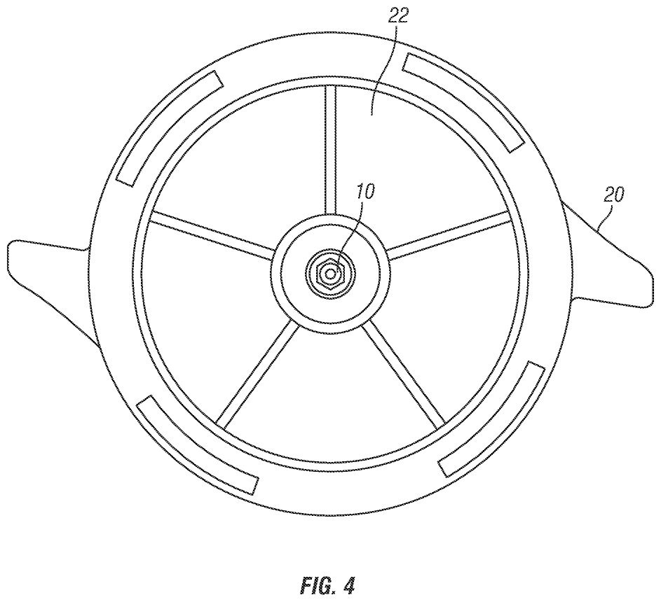

FIG. 5 is a perspective view of the leaf pot and cover installed on a pool filtration system.

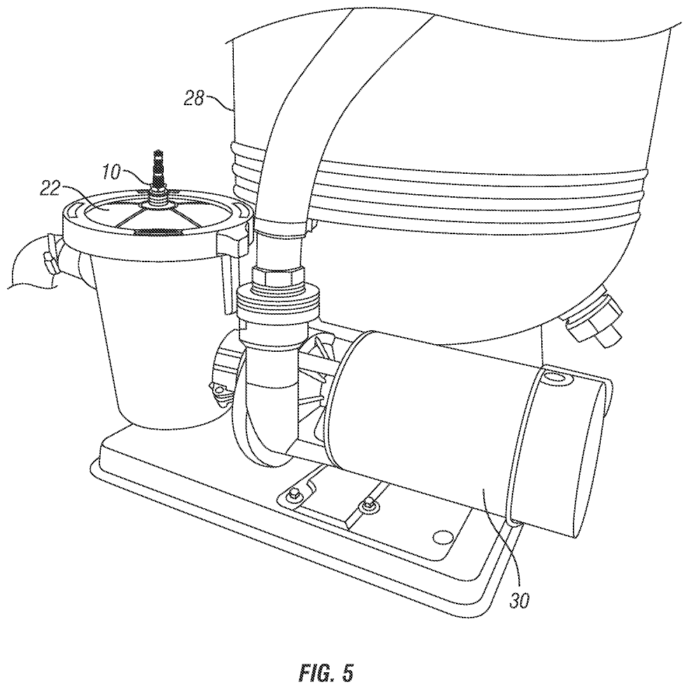

### DETAILED DESCRIPTION

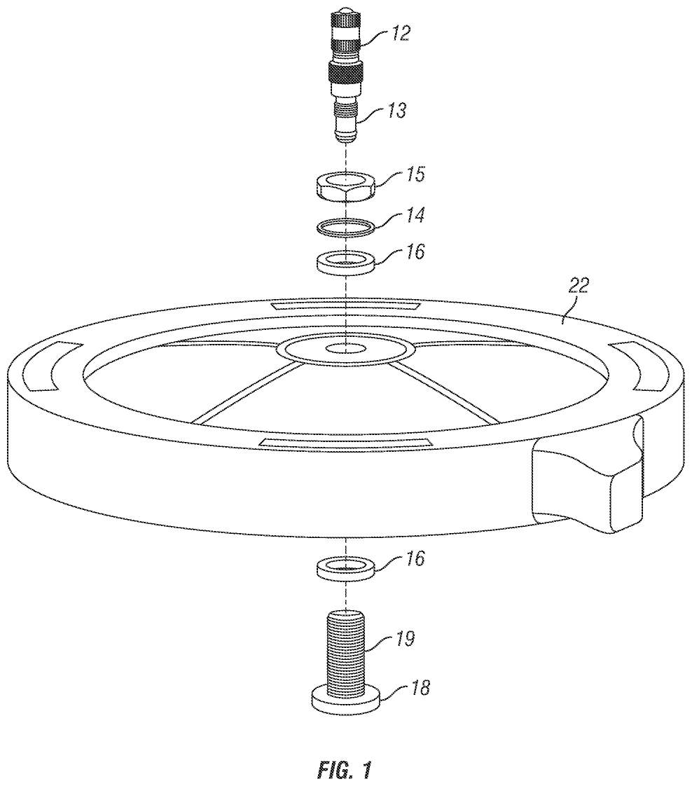

Referring now to FIG. 1 there is shown an exploded view of an air pressure relief valve 10 and its individual components including a valve stem 12 on its top end and a valve base 18 on its bottom end. The valve stem 12 is threadedly connected to a valve base 18 that has internal threads and external threads. The valve stem 12 has an internal valve core that can be pressed inward into the valve stem 12 down which allows air or water to be evacuated from a leaf pot 26. For purposes of the present invention, the air pressure relief valve 10 is located in the top of a leaf pot lid 22 whereby during the manufacturing process of the leaf pot cover 25 assembly, which includes a leaf pot outer handle 20 and a leaf pot gasket 24 including the leaf pot lid 22, there is located an aperture 23 in the top of the leaf pot lid 22 such that said air pressure relief valve 10 can be located into said aperture 23 by installing a rubber gasket 16 over the valve base 18 and then inserting the upper portion of the valve base 18 through the bottom of the aperture 23 such that a top threaded portion 19 of the valve base 18 protrudes through the aperture 23 and above the leaf pot lid 22. Once the top threaded portion 19 of the valve base 18 protrudes through the aperture 23, a rubber gasket 16 is installed over the top threaded portion 19 of the valve base and seated on top of the leaf pot lid 22. There is also a washer 14 that is installed on top of the rubber gasket 16. The valve stem 12 has a lower threaded portion 13 that is installed inside the top threaded portion 19 of the valve base 18 whereby there are inner threads located inside of the top threaded portion 19 such that the valve stem 12 is screwed into the top threaded portion 19 of the valve base 18. A locking nut 15 is then installed over the valve stem 12 and is threaded on to the outside threads of the top threaded portion 19 of the valve base 18.

The pressure release valve leaf pot lid 22 can be manufactured to include the air pressure relief 10 valve pre-installed into the leaf pot lid 22 such that a user can acquire a leaf pot lid that would allow them to replace their current leaf pot lid 22 that does not have a pressure release valve. Alternatively, the present invention can be sold as a kit whereby the air pressure release valve 10 and its various components are combined with an appropriately sized drill bit to drill an aperture 23 into the top of the leaf pot lid, and a sealant such as an adhesive silicone that allows a user to air proof the air pressure relief valve 10 connection with the leaf pot lid. The introduction of air into the leaf pot causes the pump to lose prime. Air introducing events include loss of water in a pool due to splashing activity in the pool, evaporation of water from the pool over time, and using a vacuum hose that attaches to the leaf pot whereby the vacuum hose is exposed to the atmosphere and sucks air into the system and leaf pot. What is needed in the art is a leaf pot lid that allows for easy evacuation of built-up air in the system allowing the pump to recover prime. Various different air pressure relief valves can be employed that serve the foregoing purpose and that can adequately be placed in a leaf pot lid 22.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

### ENUMERATED ELEMENTS

10 Air pressure relief valve
12 Valve Stem
13 lower threaded portion
14 Steel dome washer
15 Locking nut
16 Rubber gasket
18 Valve base
19 Top threaded portion
20 Leaf pot outer handle
22 Leaf pot lid
23 Aperture
24 Leaf pot gasket
25 Leaf pot cover assembly
26 Leaf Pot
28 Filtration system
30 Pump

What is claimed is:

1. A pressure relieving system for a leaf pot, comprising:
a leaf pot lid;
an aperture formed in said leaf pot lid
an air pressure relief valve installed into said aperture whereby the connection of the air pressure relief valve with the leaf pot lid is airtight and wherein the aperture the aperture is formed in a top central area of said leaf pot lid and wherein the air pressure relief valve has a valve stem portion and a valve base whereby said valve base has a threaded base portion and a bottom plate portion and whereby said threaded base portion is inserted into the aperture on the bottom side of the leaf pot lid aperture and such that said bottom plate portion abuts up to the bottom surface of the leaf pot lid and said valve stem is joined to said threaded base portion on the top of the leaf pot lid and whereby a rubber grommet or gasket is located directly above the bottom plate of the threaded base portion and in contact with the bottom of the leaf pot lid, a rubber grommet or gasket located on the threaded base portion and directly in contact with the top surface of the leaf pot lid, a washer located on the valve stem such that it is in contact with the top surface of said rubber grommet or gasket located on the valve stem and a locking nut that is in threaded connection on the base valve threaded portion.

2. (canceled)

3. (canceled)

4. (canceled)

5. The leaf pot of claim 1 whereby the air pressure relief valve has a valve stem that can be pressed inward to relieve air pressure from the leaf pot.

6. A kit for depressurizing a leaf pot, comprising:
an air pressure relief valve installable into an aperture formed in the top of a leaf pot lid;
a drill bit for forming the aperture in the top of leaf pot lid such that the air pressure relief valve can be installed into and on the leaf top lid;
a sealant used to apply at the connection of the air pressure relief valve with the leaf pot lid such that it is airtight and whereby the aperture is formed is in a top central area of said leaf pot lid and the air pressure relief valve has a valve stem portion and a valve base whereby said valve base has a threaded base portion and a bottom plate portion and whereby said threaded base portion is inserted into the aperture on the bottom side of the leaf pot lid aperture such that said bottom plate portion abuts up to the bottom surface of the leaf pot lid and said valve stem is joined to said threaded base portion of the valve base on the top of the leaf pot lid and whereby a rubber grommet or gasket is located directly above the bottom plate of the threaded base portion and in contact with the bottom of the leaf pot lid, a rubber grommet or gasket located on the threaded base portion and directly in contact with the top surface of the leaf pot lid, a washer located on the valve stem such that it is in contact with the top surface of said rubber grommet or gasket located on the valve stem and a locking nut that is in threaded connection on the base valve threaded portion.

7. (canceled)

8. (canceled)

9. (canceled)

10. A method for relieving air pressure in a leaf pot comprising the steps of:
forming an aperture in a leaf pot lid such that an air pressure relief valve is installed into said aperture whereby the connection of the air pressure relief valve with the leaf pot lid is airtight and whereby the aperture is formed in a top central area of the leaf pot lid, pressing a valve core inward that is located in said air pressure relief valve such as to relieve the air pressure in the leaf pot to allow pump to recover prime, providing an air pressure relief valve that has a valve stem portion and a valve base whereby said valve base has a threaded base portion and a bottom plate portion and whereby said threaded base portion is inserted into the aperture on the bottom side of the leaf pot lid aperture and such that said bottom plate portion abuts up to the bottom surface of the leaf pot lid and said valve stem is joined to said threaded base portion on the top of the leaf pot lid and further comprising the step of providing an air pressure relief valve that has a rubber grommet or gasket located directly above the bottom plate of the threaded base portion and in contact with the bottom of the leaf pot lid, a rubber grommet or gasket located on the threaded base portion and directly in contact with the top surface of the leaf pot lid, a washer located on the valve stem such that it is in contact with the top surface of said rubber grommet or gasket located on the valve stem and a locking nut that is in threaded connection on the base valve threaded portion.

11. (canceled)

12. (canceled)
